(19) United States
(12) Patent Application Publication
(10) Pub. No.: US 2024/0076422 A1
(43) Pub. Date: Mar. 7, 2024

(54) SUPPORTED METALLOCENE CATALYST, METHOD FOR PREPARING THE SAME, AND USE OF THE SAME FOR PREPARING POLYOLEFIN

(71) Applicant: National Chung Cheng University, Minsyong Township (TW)

(72) Inventors: Jing-Cherng TSAI, Minsyong Township (TW); Jen-Long WU, Minsyong Township (TW); Wen-Hao KANG, Minsyong Township (TW); Kuei-Pin LIN, Minsyong Township (TW); Jing-Yu LEE, Minsyong Township (TW); Jun-Ye HONG, Minsyong Township (TW); Zih-Yu SHIH, Minsyong Township (TW); Cheng-Hung CHIANG, Minsyong Township (TW); Gang-Wei SHEN, Minsyong Township (TW); Yu-Chuan SUNG, Minsyong Township (TW); Chung-Hua WENG, Minsyong Township (TW); Hsing-Ya CHEN, Minsyong Township (TW)

(21) Appl. No.: 18/460,381

(22) Filed: Sep. 1, 2023

(30) Foreign Application Priority Data
Sep. 2, 2022 (TW) 111133366

(51) Int. Cl. C08F 4/16; C08F 4/02; C08F 4/12; C08F 4/18; C08F 110/02

(52) U.S. Cl. CPC C08F 4/16; C08F 4/025; C08F 4/12; C08F 4/18; C08F 110/02

(57) ABSTRACT

A supported metallocene catalyst includes a carrier and a metallocene component. The carrier includes an inorganic oxide particle and an alkyl aluminoxane material. The inorganic oxide particle includes at least one inorganic oxide compound selected from the group consisting of an oxide of Group 3A and an oxide of Group 4A. The alkyl aluminoxane material includes an alkyl aluminoxane compound and an alkyl aluminum compound that is present in amount ranging from greater than 0.01 wt % to less than 14 wt % base on 100 wt % of the alkyl aluminoxane material. The metallocene component is supported on the carrier, and includes one of a metallocene compound containing a metal from Group 3B, a metallocene compound containing a metal from Group 4B, and a combination thereof. A method for preparing the supported metallocene catalyst and a method for preparing polyolefin using the supported metallocene catalyst are also disclosed.

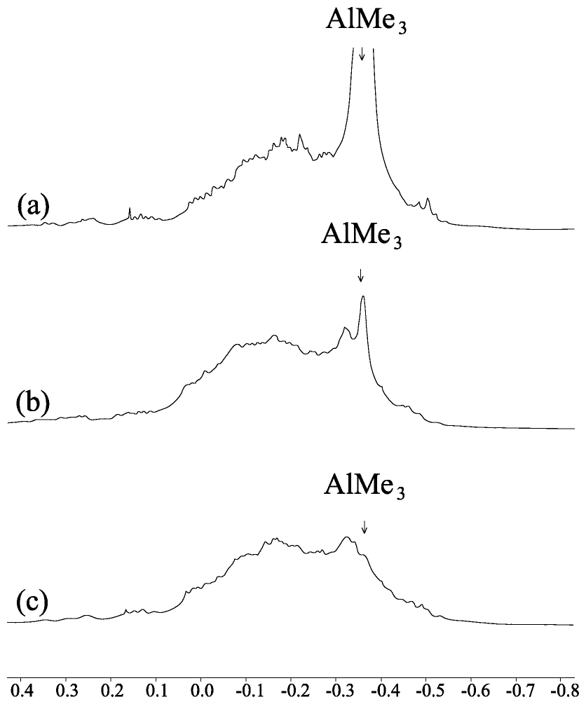

### CROSS-REFERENCE TO RELATED APPLICATION

This application claims priority to Taiwanese Invention Patent Application No. 111133366, filed on Sep. 2, 2022.

### FIELD

The disclosure relates to a catalyst, and more particularly to a supported metallocene catalyst, and a preparation method and use thereof.

### BACKGROUND

Chinese Invention Patent Publication No. 1095476C discloses a titanium metallocene catalyst for preparing full density polyethylene. The titanium metallocene catalyst includes an inorganic carrier compound, and a mono(cyclopentadienyl)titanium compound and an alkyl aluminoxane material that are supported on the inorganic carrier compound. The inorganic carrier compound might be silicon dioxide, magnesium chloride, magnesium hydroxide chloride, or aluminum oxide. The alkyl aluminoxane material contains an alkyl aluminoxane and an alkyl aluminum that is present in an amount ranging from 14 wt % to 25 wt % based on a total weight of the alkyl aluminoxane material. A mole ratio of the aluminum in the alkyl aluminoxane material to the titanium in the mono(cyclopentadienyl)titanium compound ranges from 50 to 400.

The titanium metallocene catalyst of the above-mentioned patent can reach the highest catalytic activity of 1.8 kg polyethylene/g titanium under normal pressure, enabling a polymerization of ethylene or ethylene/α-olefin to take place so as to prepare high-density polyethylene polymers having a density ranging from 0.88 g/cm³ to 0.95 g/cm³ and even distributions of molecular weight and branched chain.

However, in addition to the catalytic activity for preparing polyolefin of the titanium metallocene catalyst, the stability of a metallocene supported on the carrier compound and the state of the polyolefin prepared thereby are other key factors to be considered so as to avoid formation of viscous polymers, thereby reducing the possibility of reactor fouling and pipeline blockage during the preparation of the polyolefin.

Accordingly, there is still a need to develop a metallocene catalyst that has excellent catalytic activity and stability and/or is less likely to cause reactor fouling and pipeline blockage during the preparation of polyolefin.

### SUMMARY

Therefore, objects of the disclosure are to provide a supported metallocene catalyst, a method for preparing the same, and a method for preparing polyolefin using the same that can alleviate at least one of the drawbacks of the prior art.

According to a first aspect of the disclosure, the supported metallocene catalyst includes a carrier and a metallocene component.

The carrier includes an inorganic oxide particle and an alkyl aluminoxane material. The inorganic oxide particle includes at least one inorganic oxide compound selected from the group consisting of an oxide of Group 3A and an oxide of Group 4A. The alkyl aluminoxane material includes an alkyl aluminoxane compound and an alkyl aluminum compound that is present in amount ranging from greater than 0.01 wt % to less than 14 wt % based on 100 wt % of the alkyl aluminoxane material.

The metallocene component is supported on the carrier, and includes one of a metallocene compound containing a metal from Group 3B, a metallocene compound containing a metal from Group 4B, and a combination thereof.

According to a second aspect of the disclosure, the method for preparing the aforesaid supported metallocene catalyst includes the steps of:
(a) contacting an alkyl aluminoxane material with an inorganic oxide particle so as to form a carrier, wherein the alkyl aluminoxane material includes an alkyl aluminoxane compound and an alkyl aluminum compound that is present in amount ranging from greater than 0.01 wt % to less than 14 wt % based on 100 wt % of the alkyl aluminoxane material, and wherein the inorganic oxide particle includes at least one inorganic oxide compound selected from the group consisting of an oxide of Group 3A and an oxide of Group 4A; and
(b) supporting a metallocene component on the carrier, wherein the metallocene component includes one of a metallocene compound containing a metal from Group 3B, a metallocene compound containing a metal from Group 4B, and a combination thereof.

According to a third aspect of the disclosure, the method for preparing polyolefin includes the step of subjecting a polymeric component including at least one olefin compound to a polymerization reaction in the presence of the aforesaid supported metallocene catalyst.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

The figure is a nuclear magnetic resonance spectra illustrating trimethylaluminum contents in alkyl aluminoxane materials obtained at different purification procedures.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

For the purpose of this specification, it will be clearly understood that the word “comprising” means “including but not limited to”, and that the word “comprises” has corresponding meaning.

The present disclosure provides an embodiment of a supported metallocene catalyst including a carrier and a metallocene component that is supported on the carrier. The carrier includes an inorganic oxide particle and an alkyl aluminoxane material.

### Carrier

### Inorganic Oxide Particle

The inorganic oxide particle includes at least one inorganic oxide compound. The inorganic oxide compound may include an oxide of Group 3A, an oxide of Group 4A, or a combination thereof. The oxide of Group 3A may be, but is not limited to, aluminum oxide compound such as aluminum (lll) oxide (Al₂O₃). The oxide of Group 4A may be, but is not limited to, silicon oxide compound such as silicon dioxide (SiO₂). In certain embodiments, the inorganic oxide particle includes a granular aluminum (lll) oxide (Al₂O₃), a granular silicon dioxide (SiO₂), or a combination thereof. The inorganic oxide particle may also include water that is absorbed on a surface of the inorganic oxide compound. The inorganic oxide particle may be, for example, a calcined inorganic oxide particle obtained by a calcining treatment. The calcining treatment may be conducted at a temperature of, for instance, 150° C.

### Alkyl Aluminoxane Material

The alkyl aluminoxane material includes an alkyl aluminoxane compound and an alkyl aluminum compound that is present in amount ranging from greater than 0.01 wt % to less than 14 wt % based on 100 wt % of the alkyl aluminoxane material.

The alkyl aluminoxane compound may be, but is not limited to, methylaluminoxane.

The alkyl aluminum compound may be, but is not limited to, trimethylaluminum. In certain embodiments, the alkyl aluminum compound includes trimethylaluminum. In certain embodiments, the alkyl aluminum compound is present in amount ranging from 0.1 wt % to 12 wt % based on 100 wt % of the alkyl aluminoxane material. In other embodiments, the alkyl aluminum compound is present in amount ranging from 0.1 wt % to 5.5 wt % based on 100 wt % of the alkyl aluminoxane material.

It is noted that a conventional alkyl aluminoxane material for preparing a metallocene catalyst includes the alkyl aluminum compound in a relatively high amount, resulting in a lower ratio of aluminum to silicon. Consequently, the metallocene catalyst thus prepared exhibits a relatively low polymerization activity in preparation of polyolefin. The alky aluminoxane material according to the disclosure, however, contains a relatively lower amount of the alkyl aluminum compound, thereby being capable of enhancing the polymerization activity of the supported metallocene catalyst of this disclosure.

In certain embodiments, the alkyl aluminoxane material of this disclosure, which contains a relatively lower amount of the alkyl aluminum compound, may be obtained by employing purification procedures as described below.

Specifically, the alkyl aluminum compound is reacted with water to obtain a crude product, followed by purifying the crude product. The purifying procedures may include, but are not limited to, a concentration under reduced pressure (such as vacuum concentration), an organic solvent washing, and a combination thereof. For example, during the purification procedures, the crude product is dissolved in a solvent and then is subjected to vacuum distillation to remove substances having low boiling points, followed by adding a high boiling point solvent and conducting distillation under reduced pressure to remove residual alkyl aluminum compound, so as to obtain the alkyl aluminoxane material in powder form which contains a relatively lower amount of the alkyl aluminum compound. The thus obtained alkyl aluminoxane material may be further purified by conducting washing using an organic solvent one or more times, followed by drying under reduced pressure, so as to obtain a refined alkyl aluminoxane material in powder form which contains a much lower amount of the alkyl aluminum compound.

In an exemplary embodiment, a commercially available alkyl aluminoxane material, which is a crude product prepared by reacting trimethylaluminum with water, is dissolved in toluene and then is subjected to vacuum distillation to remove substances having low boiling points, followed by adding dimethylbenzene and conducting distillation under reduced pressure to remove residual trimethylaluminum, so as to obtain the alkyl aluminoxane material in powder form. In another exemplary embodiment, the alkyl aluminoxane material as prepared above is further washed with n-heptane three times, and then dried under reduced pressure, so as to obtain the refined alkyl aluminoxane material in powder form. The figure shows upfield ¹H-nuclear magnetic resonance (¹H-NMR) spectra of the crude product (panel (a)), the alkyl aluminoxane material (panel (b)) and the refined alkyl aluminoxane material (panel (c)). The crude product is determined to include 27.35 wt % of trimethylaluminum and 72.65 of methylaluminoxane. The alkyl aluminoxane material is determined to include 2.13 wt % of trimethylaluminum and 97.87 wt % of methylaluminoxane. The refined alkyl aluminoxane material is determined to include 0.17 wt % of trimethylaluminum and 99.83 wt % of methylaluminoxane.

### Metallocene Component

The metallocene component includes one of a metallocene compound containing a metal from Group 3B, a metallocene compound containing a metal from Group 4B, and a combination thereof.

Examples of the metallocene compound may include, but are not limited to, a metallocene compound containing titanium, a metallocene compound containing zirconium, a metallocene compound containing hafnium, and combinations thereof.

The metallocene compound containing zirconium may be, but is not limited to, bis-(n-butylcyclopentadienyl)zirconium dichloride ((ⁿBuCp)₂ZrCl₂), bis-(n-propylcyclopentadienyl)zirconium dichloride, bis-(ethylcyclopentadienyl)zirconium dichloride, bis-(methylcyclopentadienyl)zirconium dichloride, bis-(1,3-dimethyl cyclopentadienyl)zirconium dichloride, bis-(1-butyl-3-methylcyclopentadienyl)zirconium dichloride, ethylene bis(indenyl) zirconium dichloride (C₂H₄(Ind)₂ZrCl₂), dimethylsilylene-bis-(2-methylindenyl)zirconium dichloride, dimethylsilylene-bis-(indenyl)zirconium dichloride (Me₂Si(Ind)₂ZrCl₂), and dimethylsilylene-bis-(2-methyl-4-phenylindenyl)zirconium dichloride (Me₂Si(2-Me-4-Ph-1-Ind)₂ZrCl₂).

The metallocene compound containing hafnium may be, but is not limited to, bis(cyclopentadienyl)hafnium dichloride, bis(ethylcyclopentadienyl)hafnium dichloride, and bis(isopropylcyclopentadienyl)hafnium dichloride.

In certain embodiments, the metallocene compound includes at least one selected from the group consisting of bis-(n-butylcyclopentadienyl)zirconium dichloride ((ⁿBuCp)₂ZrCl₂), dimethylsilylene-bis-(indenyl)zirconium dichloride (Me₂Si(Ind)₂ZrCl₂), ethylene bis(indenyl) zirconium dichloride (C₂H₄(Ind)₂ZrCl₂), and dimethylsilylene-bis-(2-methyl-4-phenylindenyl)zirconium dichloride (Me₂Si(2-Me-4-Ph-1-Ind)₂ZrCl₂).

The carrier and the metallocene component may be present in the supported metallocene catalyst in a weight ratio that ranges from 10:1 to 600:1. In certain embodiments, the carrier and the metallocene component are present in a weight ratio that ranges from 50:1 to 250:1.

### Method for Preparing the Supported Metallocene Catalyst

According to the disclosure, a method for preparing the above-mentioned supported metallocene catalyst includes the steps of contacting the alkyl aluminoxane material with the inorganic oxide particle so as to form the carrier, and supporting the metallocene component on the carrier.

The alkyl aluminoxane material and the inorganic oxide particle of the carrier, and the metallocene component are the same as those described above and thus are omitted herein for the sake of brevity.

### Method for Preparing Polyolefin Using the Supported Metallocene Catalyst

According to the disclosure, the supported metallocene catalyst exhibits an excellent polymerization activity, and thus, is suitable for the preparation of polyolefin. Therefore, the disclosure also provides a method for preparing polyolefin which includes subjecting a polymeric component including at least one olefin compound to a polymerization reaction in the presence of the supported metallocene catalyst as mentioned above.

The supported metallocene catalyst according to the disclosure is capable of controlling the morphology of polyolefin, so that the polyolefin thus prepared may have improved uniformity. In addition, since the supported metallocene catalyst and polyolefin have high fluidity, they are less prone to precipitation during the polymerization reaction, so as to effectively prevent the issues of reactor fouling and pipeline blockage.

Examples of the olefin compound may include, but are not limited to, ethylene, propene, 1-butene, 1-hexene, 1-octene, 5-ethylidene-2-norbornene, dicyclopentadiene, 1,4-hexadiene, 1,5-heptadiene, and combinations thereof. In certain embodiments, the olefin compound is ethylene, propene, 1-hexene, or combinations thereof.

Parameters and conditions of the polymerization reaction suitable for this disclosure are within the expertise and routine skills of those skilled in the art, and may be adopted from those commonly used in conventional polymerization reactions and thus are not further described herein for simplicity.

Examples of the polyolefin may include, but are not limited to, a high density polyethylene (HDPE), a linear low-density polyethylene (LLDPE), an ultra low density polyethylene (ULDPE), an ethylene-propylene rubber (EPR), and an ethylene propylene diene monomer (EPDM).

The present disclosure will be described by way of the following examples. However, it should be understood that the following examples are intended solely for the purpose of illustration and should not be construed as limiting the present disclosure in practice.

### Carrier

### Preparative Example 1 (PE1) of the Carrier

First, an alkyl aluminoxane component containing 2.13 wt % of trimethylaluminum and 97.87 wt % of methylaluminoxane was provided. Next, 4 g of the alkyl aluminoxane component, 3.77 mL of a trimethylaluminum solution (2 M in toluene), and 41.2 mL of toluene were mixed under stirring, followed by slowly increasing the temperature to 110° C. and then stirring for 3 hours at 110° C., so as to form a first mixed solution containing an alkyl aluminoxane material and toluene. The alkyl aluminoxane material included 13.82 wt % of trimethylaluminum and 86.18 wt % of methylaluminoxane.

Afterwards, 2.5 g of silicon dioxide particles which had been calcined for 3 hours at 150° C., and 100 ml of toluene (as a solvent) were added to the first mixed solution. The resultant product was cooled down to room temperature, and then slowly heated to 100° C. to mix under stirring for 24 hours at 100° C., followed by cooling down to room temperature, thereby obtaining a second mixed solution containing a carrier in a white solid precipitated form.

Subsequently, the second mixed solution was filtrated so as to obtain a filter cake containing the carrier and impurities. The filter cake was washed three times using a purifying agent containing toluene and n-pentane (in a weight ratio of 1:3), followed by drying so as to obtain the carrier of PE1 in white powder form.

### Preparative Example 2 (PE2)

The carrier of PE2 was prepared using procedures generally similar to those of PE1, except that in PE2, the first mixed solution was obtained by mixing the alkyl aluminoxane component with 1.64 mL of the trimethylaluminum solution and 43.4 mL of the toluene, and no toluene was added into the first mixed solution for obtaining the second mixed solution.

### Preparative Example 3 (PE3)

First, an alkyl aluminoxane material containing 2.13 wt % of trimethylaluminum and 97.87 wt % of methylaluminoxane, and silicon dioxide particles that had been calcined for 3 hours at 150° C. were provided.

Subsequently, 4 g of the alkyl aluminoxane material, 2.5 g of the silicon dioxide particles, and 100 mL of toluene (as a solvent) were mixed under stirring at room temperature, and then slowly heated to 100° C., and further stirred at 100° C. for 24 hours, followed by cooling down to room temperature, thereby obtaining a mixed solution containing the carrier in white solid precipitated form.

Afterwards, the mixed solution was filtrated so as to obtain a filter cake containing the carrier and impurities. The filter cake was then washed three times using a purifying agent containing toluene and n-pentane (in a weight ratio of 1:3), followed by drying, so as to obtain the carrier of PE3 in white powder form.

### Preparative Examples 4 to 6 (PE4 to PE6) and Comparative Preparative

### Example 1 (CPE1)

The carrier of each of PE4 to PE6 and CPE1 was prepared using procedures generally similar to those of PE3 except for the variation in the weights of silicon dioxide particles and the alkyl aluminoxane material, and/or the amounts of trimethylaluminum and methylaluminoxane in the alkyl aluminoxane material. The details thereof were shown in Table 1.

### Comparative Preparative Example 2 (CPE2)

The carrier of CPE2 was prepared using procedures generally similar to those of PE1, except that in CPE2, the first mixed solution was obtained by mixing the alkyl aluminoxane component with 4.45 mL of the trimethylaluminum solution and 40 mL of toluene.

The carriers of PE1 to PE6, CPE1 and CPE2 were subjected to analysis using an inductively coupled plasma mass spectrometer (ICP-MS), so as to determine a weight ratio of aluminum to silicon thereof.

TABLE 1

| | | CPE1 | CPE2 | PE1 | PE2 | PE3 | PE4 | PE5 | PE6 |
|---|---|---|---|---|---|---|---|---|---|
| Inorganic | Silicon | 2.5 | 2.5 | 2.5 | 2.5 | 2.5 | 2.5 | 2 | 2 |
| oxide | dioxide | | | | | | | | |
| particle | particle (g) | | | | | | | | |
| Alkyl | Trimethylaluminum | 27.35 | 15.66 | 13.82 | 7.59 | 2.13 | 0.17 | 5.15 | 3.57 |
| aluminoxane | (wt %) | | | | | | | | |
| material | Methylaluminoxane | 72.65 | 84.34 | 86.18 | 92.41 | 97.87 | 99.83 | 94.85 | 96.43 |
| | (wt %) | | | | | | | | |
| | Total weight (g) | 4.0 | — | — | — | 4.0 | 4.0 | 3 | 2.96 |
| Solvent | Toluene (mL) | 100 | 100 | 100 | 0 | 100 | 100 | 100 | 100 |
| Carrier | Aluminum/silicon | 0.604 | 0589 | 0.662 | 1.087 | 0.998 | 0.840 | — | — |
| | Methylaluminoxane | — | — | — | — | — | — | 48.8 | 51.2 |
| | (wt %) | | | | | | | | |

### Supported Metallocene Catalyst

### Example 1 (E1)

The carrier of PE1 (0.031 g) was mixed with 0.14 mL of a solution of a metallocene component (i.e., 0.01 M bis-(n-butylcyclopentadienyl)zirconium dichloride dissolved in toluene) and 5 mL of toluene under stirring at room temperature for 0.5 hours, such that the bis-(n-butylcyclopentadienyl)zirconium dichloride was supported on the carrier, thereby forming a catalyst solution containing a supported metallocene catalyst of E1. A weight ratio of the aluminum in the carrier to the zirconium in the bis-(n-butylcyclopentadienyl)zirconium dichloride was 150.

### Examples 2 to 13 (E2 to E8) and Comparative Examples 1 and 3 (CE1 and CE3)

The supported metallocene catalyst of each of E2 to E8 and CE1 to CE2 was prepared using procedures generally similar to those of E1, except for the variation in types of the carriers, and/or types and amounts of the metallocene components (in solution form) which are shown in Table 2. Specifically, the metallocene component used in each of E2, E3, E7, E8, CE1 and CE3 was bis-(n-butylcyclopentadienyl)zirconium dichloride. In E4, the metallocene components used in E4, E5 and E6 were dimethylsilylene-bis-(indenyl)zirconium dichloride ethylene bis(indenyl) zirconium dichloride, and dimethylsilylene-bis-(2-methyl-4-phenylindenyl)zirconium dichloride, respectively.

### Examples 9 to 13 (E9 to E13)

The supported metallocene catalyst of each of E9 to E13 was prepared using procedures generally similar to those of E1, except for the variation in types of the carriers, and/or types and amounts of the metallocene components which are shown in Table 2. Specifically, in each of E9 to E13, the metallocene components were in solid form. The metallocene component used in E9 and E10 was bis-(n-butylcyclopentadienyl)zirconium dichloride. In addition, the metallocene components used in E11 to E13 were dimethylsilylene-bis-(indenyl)zirconium dichloride, dimethylsilylene-bis-(indenyl)zirconium dichloride, and dimethylsilylene-bis-(2-methyl-4-phenylindenyl)zirconium dichloride, respectively.

### Comparative Example 2 (CE2)

The supported metallocene catalyst of CE2 was prepared using procedures generally similar to those of CE1, except that the catalyst solution was further filtrated to obtain a filter cake which was then washed three times using a purifying agent containing toluene and n-hexane (in a weight ratio of 1:3), followed by drying, so as to obtain the supported metallocene catalyst of CE2.

TABLE 2

| | | Comparative | | | | | | | | | | | | | | | |
|---|---|---|---|---|---|---|---|---|---|---|---|---|---|---|---|---|---|
| | | Example | | | Example | | | | | | | | | | | | |
| | | 1 | 2 | 3 | 1 | 2 | 3 | 4 | 5 | 6 | 7 | 8 | 9 | 10 | 11 | 12 | 13 |
| Carrier | CPE1 | 3.1 | 3.1 | 0 | 0 | 0 | 0 | 0 | 0 | 0 | 0 | 0 | 0 | 0 | 0 | 0 | 0 |
| (×10⁻² g) | CPE2 | 0 | 0 | 3.1 | 0 | 0 | 0 | 0 | 0 | 0 | 0 | 0 | 0 | 0 | 0 | 0 | 0 |
| | PE1 | 0 | 0 | 0 | 3.1 | 0 | 0 | 3.1 | 3.1 | 0 | 0 | 0 | 0 | 0 | 0 | 0 | 0 |
| | PE2 | 0 | 0 | 0 | 0 | 3.1 | 0.7 | 0 | 0 | 3.1 | 0 | 0 | 0 | 0 | 0 | 0 | 0 |
| | PE3 | 0 | 0 | 0 | 0 | 0 | 0 | 0 | 0 | 0 | 3.1 | 0 | 0 | 0 | 0 | 0 | 0 |
| | PE4 | 0 | 0 | 0 | 0 | 0 | 0 | 0 | 0 | 0 | 0 | 3.1 | 0 | 0 | 0 | 0 | 0 |
| | PE5 | 0 | 0 | 0 | 0 | 0 | 0 | 0 | 0 | 0 | 0 | 0 | 3.1 | 0 | 3.1 | 0 | 0 |
| | PE6 | 0 | 0 | 0 | 0 | 0 | 0 | 0 | 0 | 0 | 0 | 0 | 0 | 3.1 | 0 | 3.1 | 3.1 |
| Metallocene | M1 | 0.13 | 0.13 | 0.14 | 0.13 | 0.18 | 0.05 | — | — | — | — | — | | | | | |
| component | M2 | — | — | — | — | — | — | 0.14 | — | — | — | — | | | | | |
| in solution | M3 | — | — | — | — | — | — | — | 0.14 | — | — | — | | | | | |
| form (mL) | M4 | — | — | — | — | — | — | — | — | — | — | — | | | | | |
| Metallocene | M1 | | | | | | | | | | | | 0.4 | 0.4 | | | |
| component | M2 | | | | | | | | | | | | — | — | 4.2 | 4.5 | — |
| in solid | M4 | | | | | | | | | | | | — | — | — | — | 4.5 |
| form (×10⁻³ g) | | | | | | | | | | | | | | | | | |

Note:
M1 refers to bis-(n-butylcyclopentadienyl)zirconium dichloride ((ⁿBuCp)₂ZrCl₂).
M2 refers to dimethylsilylene-bis-(indenyl)zirconium dichloride (Me₂Si(Ind)₂ZrCl₂).
M3 refers to ethylene bis(indenyl) zirconium dichloride (C₂H₄(Ind)₂ZrCl₂).
M4 refers to dimethylsilylene-bis-(2-methyl-4-phenylindenyl)zirconium dichloride (Me₂Si(2-Me-4-Ph-1-Ind)₂ZrCl₂).

### Preparation of Polyolefin

### Application Example 1 (AE1)

500 mL of heptane and 0.5 mL of a triethylaluminum solution (1 M triethylaluminum in toluene) were placed in a reactor filled with nitrogen gas, and the temperature of the reactor was raised to 80° C. Then, a metallocene catalyst solution (which included toluene and the catalyst solution containing the supported metallocene catalyst of E1) was added into the reactor, and 15 bars of an olefin compound (ethylene) was then injected into the reactor. Next, a polymerization reaction was carried out at 80° C. for 30 minutes, and then was terminated by adding 10 mL of methanol into the reactor so as to form a reaction product containing polyethylene. Afterwards, the reaction product was filtered, and then the resultant filter cake was vacuum-dried at 60° C., thereby obtaining 48.05 g of polyethylene.

### Application Examples 2 to 13 (AE2 to AE13) and Comparative Application

### Examples 1 to 3 (CAE 1 to 3)

Referring to Tables 3 and 4, each of AE2 to AE13, and CAE1 to CAE3 was conducted using procedures generally similar to those of AE1 except for the variations in types of the supported metallocene catalyst, types of the olefin compound, and time and pressure of the polymerization reaction. Specifically, the olefin compound used in each of AE2 to AE4, AE7 to AE11 , and CAE1 to CAE3 was ethylene. In addition, in, the olefin compound used in each of AE5 and AE12 was ethylene in combination with 8 mL of 1-hexene, and that used in each of AE6 and AE13 was propylene.

### Evaluation

The supported metallocene catalyst (kg/(g×hr)) used in each of AE1 to AE13 and CE1 to CE13 was subjected to determination of catalytic activity which was calculated using the following formula:

A=B/(C×D)
A=catalytic activity of the supported metallocene catalyst
B=yield of the polyolefin (kg)
C=weight of the catalyst solution (g)
D=time for the polymerization reaction (hour)

TABLE 3

| | | Application Example | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Triethyl- | Volume | 0.5 | 0.5 | 0.5 | 0.5 | 0.5 | 0.5 | 0.5 | 0.5 | 0.5 | 0.5 | 0.5 | 0.5 | 0.5 |
| aluminum | (mL) | | | | | | | | | | | | | |
| solution | | | | | | | | | | | | | | |
| Catalyst | Example | 1 | 2 | 3 | 4 | 5 | 6 | 7 | 8 | 9 | 10 | 11 | 12 | 13 |
| solution | | | | | | | | | | | | | | |
| Olefin | Ethylene | 15 | 15 | 22 | 15 | 15 | — | 15 | 15 | 15 | 15 | 15 | 15 | — |
| compound | (bar) | | | | | | | | | | | | | |
| | Propylene | — | — | — | — | — | 10 | — | — | — | — | — | — | 10 |
| | (bar) | | | | | | | | | | | | | |
| | 1-hexene | — | — | — | — | — | — | — | — | — | — | — | — | — |
| | (mL) | | | | | | | | | | | | | |
| Polymerization | Time | 30 | 30 | 60 | 30 | 30 | 30 | 30 | 30 | 30 | 30 | 30 | 30 | 30 |
| reaction | (min) | | | | | | | | | | | | | |
| Catalytic activity (kg/(g × hr)) | | 3.05 | 5.04 | 13.86 | 2.69 | 1.54 | 1.75 | 4.24 | 3.48 | 2.79 | 4.98 | 2.75 | 1.47 | 1.57 |
| Polyolefin | Yield (g) | 48.05 | 80.0 | 99.8 | 42.6 | 24.4 | 27.9 | 67.2 | 55.1 | 48.05 | 80 | 42.6 | 24.4 | 27.9 |
| | Density | 0.209 | 0.298 | 0.314 | 0.255 | 0.923 | — | 0.247 | 0.230 | — | — | — | 0.923 | — |
| | (g/cm³) | | | | | | | | | | | | | |

| | |
|---|---|
| Morphology | Granular |

TABLE 4

| | | Comparative Application Example | | |
|---|---|---|---|---|
| | | 1 | 2 | 3 |
| Triethylaluminum | Volume | 0.5 | 0.5 | 0.5 |
| solution | (mL) | | | |
| Catalyst | Comparative | 1 | 2 | 3 |
| solution | Example | | | |
| Olefin | Ethylene | 15 | 15 | 15 |
| compound | (bar) | | | |
| Polymerization | Time | 30 | 30 | 30 |
| reaction | (min) | | | |
| Catalytic activity (kg/(g × hr)) | | 2.79 | 1.01 | 1.87 |
| Polyolefin | Yield (g) | 43.94 | 15.91 | 29.51 |
| | Density | 0.187 | 0.173 | 0.205 |
| | (g/cm³) | | | |

| | | |
|---|---|---|
| Morphology | Granular | Granular and |
| | and block | flake-like |

Referring to Tables 3 and 4, when the supported metallocene catalyst used for synthesizing the polyolefin in each of AE1 to AE13 includes the alkyl aluminum compound that is present in an amount ranging from greater than 0.01 wt % to less than 14 wt % based on 100 wt % of the alkyl aluminoxane material, the polyolefin thus obtained has a granular morphology and improved uniformity, indicating that the issues of reactor fouling and pipeline blockage are effectively reduced and that the metallocene component of the supported metallocene catalyst can be stably supported on the carrier.

In contrast, in each of CAE1 to CAE3, the supported metallocene catalyst used for synthesizing the polyolefin includes the alkyl aluminum compound that is present in an amount of 27.35 wt % or 15.66 wt % based on 100% wt % of the alkyl aluminoxane material, so that the polyolefin thus obtained has granular and block morphologies or granular and flake-like morphologies without uniformity, indicating that the issues of reactor fouling and pipeline blockage tend to occur and that the metallocene component of the supported metallocene catalyst are not stably supported on the carrier.

In sum, by virtue of reducing the amount of the alkyl aluminum compound in the alkyl aluminoxane material, the supported metallocene catalyst of the disclosure has an improved catalytic activity for synthesizing the polyolefin under a condition of either a gas phase or a slurry phase, and exhibits an enhanced supporting stability of the metallocene component on the carrier, so that the polyolefin prepared thereby can have solid granular morphology with uniformity, and is not present in viscous form. Therefore, the issues of reactor fouling and pipeline blockage during the preparation of the polyolefin can be effectively reduced.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A supported metallocene catalyst, comprising:
a carrier including
an inorganic oxide particle which includes at least one inorganic oxide compound selected from the group consisting of an oxide of Group 3A and an oxide of Group 4A, and
an alkyl aluminoxane material which includes an alkyl aluminoxane compound and an alkyl aluminum compound that is present in amount ranging from greater than 0.01 wt % to less than 14 wt % based on 100 wt % of said alkyl aluminoxane material; and
a metallocene component supported on said carrier, and including one of a metallocene compound containing a metal from Group 3B, a metallocene compound containing a metal from Group 4B, and a combination thereof.

2. The supported metallocene catalyst as claimed in claim 1, wherein said inorganic oxide compound is selected from the group consisting of aluminum oxide compound, silicon oxide compound, and a combination thereof.

3. The supported metallocene catalyst as claimed in claim 2, wherein said aluminum oxide compound includes aluminum (lll) oxide, and said silicon oxide compound includes silicon dioxide.

4. The supported metallocene catalyst as claimed in claim 1, wherein said alkyl aluminum compound includes trimethylaluminum.

5. The supported metallocene catalyst as claimed in claim 1, wherein said alkyl aluminum compound is present in an amount ranging from 0.1 wt % to 12 wt % based on 100 wt % of said alkyl aluminoxane material.

6. The supported metallocene catalyst as claimed in claim 1, wherein said metallocene component includes at least one selected from the group consisting of a metallocene compound containing titanium, a metallocene compound containing zirconium and a metallocene compound containing hafnium.

7. The metallocene catalyst as claimed in claim 6, wherein said metallocene component includes at least one selected from the group consisting of bis-(n-butylcyclopentadienyl)zirconium dichloride, bis-(n-propylcyclopentadienyl)zirconium dichloride, bis-(ethylcyclopentadienyl)zirconium dichloride, bis-(methylcyclopentadienyl)zirconium dichloride, bis-(1,3-dimethyl cyclopentadienyl)zirconium dichloride, bis-(1-butyl-3-methylcyclopentadienyl)zirconium dichloride, ethylene bis(indenyl) zirconium dichloride, dimethylsilylene-bis-(2-methylindenyl)zirconium dichloride, dimethylsilylene-bis-(indenyl)zirconium dichloride, dimethylsilylene-bis-(2-methyl-4-phenylindenyl)zirconium dichloride, bis(cyclopentadienyl)hafnium dichloride, bis(ethylcyclopentadienyl)hafnium dichloride, and bis(isopropylcyclopentadienyl)hafnium dichloride.

8. The supported metallocene catalyst as claimed in claim 1, wherein said carrier and said metallocene component are present in a weight ratio that ranges from 10:1 to 600:1.

9. A method for preparing a supported metallocene catalyst, comprising:
(a) contacting an alkyl aluminoxane material with an inorganic oxide particle so as to form a carrier, wherein the alkyl aluminoxane material includes an alkyl aluminoxane compound and an alkyl aluminum compound that is present in amount ranging from greater than 0.01 wt % to less than 14 wt % based on 100 wt % of the alkyl aluminoxane material, and wherein the inorganic oxide particle includes at least one inorganic oxide compound selected from the group consisting of an oxide of Group 3A and an oxide of Group 4A; and
(b) supporting a metallocene component on the carrier, wherein the metallocene component includes one of a metallocene compound containing a metal from Group 3B, a metallocene compound containing a metal from Group 4B, and a combination thereof.

10. The method as claimed in claim 9, wherein the inorganic oxide compound is selected from group consisting of aluminum oxide compound, silicon oxide compound, and a combination thereof.

11. The method as claimed in claim 10, wherein the aluminum oxide compound includes aluminum (lll) oxide, and the silicon oxide compound includes silicon dioxide.

12. The method as claimed in claim 9, wherein the alkyl aluminum compound includes trimethylaluminum.

13. The method as claimed in claim 9, wherein the alkyl aluminum compound is present in an amount ranging from 0.1 wt % to 12 wt % based on 100 wt % of the alkyl aluminoxane material.

14. The method as claimed in claim 9, wherein the metallocene component includes at least one selected from the group consisting of a metallocene compound containing titanium, a metallocene compound containing zirconium, and a metallocene compound containing hafnium.

15. The method as claimed in claim 14, wherein the metallocene component includes at least one selected from the group consisting of bis-(n-butylcyclopentadienyl)zirconium dichloride, bis-(n-propylcyclopentadienyl)zirconium dichloride, bis-(ethylcyclopentadienyl)zirconium dichloride, bis-(methylcyclopentadienyl)zirconium dichloride, bis-(1,3-dimethyl cyclopentadienyl)zirconium dichloride, bis-(1-butyl-3-methylcyclopentadienyl)zirconium dichloride, ethylene bis(indenyl) zirconium dichloride, dimethylsilylene-bis-(2-methylindenyl)zirconium dichloride, dimethylsilylene-bis-(indenyl)zirconium dichloride, dimethylsilylene-bis-(2-methyl-4-phenylindenyl)zirconium dichloride, bis(cyclopentadienyl)hafnium dichloride, bis(ethylcyclopentadienyl)hafnium dichloride, and bis(isopropylcyclopentadienyl)hafnium dichloride.

16. The method as claimed in claim 9, wherein the carrier and the metallocene component are present in a weight ratio that ranges from 10:1 to 600:1.

17. A method for preparing polyolefin, comprising:
subjecting a polymeric component including at least one olefin compound to a polymerization reaction in the presence of a supported metallocene catalyst as claimed in claim 1.
